(19) United States
(12) Patent Application Publication
(10) Pub. No.: US 2007/0163848 A1
(43) Pub. Date: Jul. 19, 2007

(54) Parking brake for a motor vehicle

(75) Inventors: Tilo Huber, Tiefenbach (DE); Friedrich Saibold, Passau (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/652,829

(22) Filed: Jan. 12, 2007

(30) Foreign Application Priority Data
Jan. 14, 2006 (DE) 10 2006 001 895.8

(51) Int. Cl. F16D 55/02

(52) U.S. Cl. 188/71.9

(57) ABSTRACT

A parking brake for a motor vehicle comprising a disk packet (11) on an axle body in a brake housing (1) with at least one brake disk, one spring (8), by way of which the closure of the brake can be effected by a compression of the disk packet (11) and a piston (7), superimposed on the spring (8), the compression space (6) of which piston can be subjected to hydraulic pressure for the release of the parking brake counter to the closing force of the spring and the force of the piston (7) is transferred by at least one pressure pin (4) onto a pressure transmission element (2), which the element stands in operative connection with the disk packet (11) and the piston (7), and the at least one pressure pin (4) is shape-fit decoupled from one another.

This application claims priority from German Application Serial No. 10 2006 001 895.8 filed Jan. 14, 2006.

### FIELD OF THE INVENTION

The present invention concerns a parking brake for a motor vehicle.

### BACKGROUND OF THE INVENTION

Parking brakes for motor vehicles are known within the prior state of technology. These brakes are engaged by spring action and released by the application of hydraulic pressure. Such known brakes generally possess at least one brake disk housed in an axle body and have springs for the compression of the at least one brake disk. Further, a piston is provided for the release of the brake disks, wherein a compression space therefor can be subjected to hydraulic pressure. Such brakes, for example, are installed on the axles of factory floor automated carriers and other self-operating conveyance vehicles.

The constructive design of parking brakes is also dependent upon the arrangement of the brake disks. In this design, by which both parking and service brakes act from a mutual brake-disk packet, according to the state of the technology of parking brake pistons, it may be expected to find in the brake housing at least one boring, which accommodates a pin. This pin transmits the spring force either by way of the service brake piston or directly to the brake disks. To enable this operation, the pin is retained within a cylindrical section in the boring of the piston. With this arrangement, it becomes possible that the piston of the service brake can be installed as a pressure transmission element, if the service brake and the parking brake possess disks in common.

EP 1 181 178 B1 of the Applicant makes a gear train for a parking brake known, wherein a driving motor drives a first planetary stage which, by way of a second planetary gear stage energizes a drive mechanism and, respectively, by way of a service or parking brake, which is in series with the second planetary gear stage, can serve as a braking medium. In this way, the brake possesses an activation apparatus which, in the non-pressurized state of a first part of the activation apparatus engages the brake as a parking brake. Conversely, upon application of hydraulic pressure onto the first part of the activation apparatus, the brake opens, to serve as a parking brake. To continue, the brake engages upon the application of pressure to a second part of the activation apparatus.

DE 102 01 366 A1 of the Applicant teaches of a spring force activated, hydraulic pressure released parking brake (also known as “SAHR” or Spring Applied Hydraulic Released parking brake) for motor vehicles. This brake encompasses, on an axle body in a brake housing, brake disks, a spring—with which the brake disks can be compressed together—and a piston, which is superimposed on the spring, wherein the piston compression space can be subjected to hydraulic pressure to effect the release of the brake.

In this way, the piston possesses at least one boring, which is respectively provided with a pressure pin. The pin is retained in a cylindrical section in the piston boring, whereby in this cylindrical section, this pin possesses a radial groove. According to DE 102 01 366 A1, the boring in the piston is carried out as a blind boring with the radial groove. Further, an annular spring is provided, which can be mounted in the radial groove of the cylindrical section of the pin and the blind boring in the piston. The at least one pin is operationally bound by way of a pressure transmission element to the disk packet. Normally, the piston of the service brake serves as a pressure transmission element.

This described design calls for extremely limited clearances between the functional surfaces of the pressure pin, the piston of the parking brake and the guide machining in the brake housing in order to reliably seal against an escape of the activation medium.

In order to properly engage shape-fit joints during equipment assembly, a specified clearance must exist between the boring and, respectively, the pressure pin and the piston, whereby the sealing between the pressure pin and the boring in the parking brake piston is obliged to allow for this compensatory spacing. Further a rotational movement, which would act by way of the disk packet against the pressure transmission elements, i.e., on the piston of the service brake, would be transmitted by the at least one pressure pin. These applied forces can have a negative effect on the efficiency of the sealing elements and the operational life of the sealing about the pressure pin.

Thus the present invention has the purpose of making a parking brake for motor vehicles available, which are engaged by way of spring force and released by way of a hydraulic pressure and wherein the disadvantages, which arise from a known design which is in conformity with the state of the technology are avoided. Any disadvantageous effects leading to the deterioration of the sealing elements, because of the applied forces, are also to be excluded while, simultaneously, the reliability and operational life of the components are to be increased. In addition, the invented parking brake is to be simply and easily installed.

### SUMMARY OF THE INVENTION

A parking brake for a motor vehicle is accordingly proposed, which encompasses at least one brake disk contained in a brake disk packet secured within an axle-borne body in a brake housing and further includes a spring by way of which the brake can be engaged by spring-actuated compression of the brake-disk packet and includes a further parking brake piston situated on the spring. The piston-compression space can be subjected to hydraulic pressure for the purposed of releasing the brake against the force of the spring. In this described operation, the force of the piston can be transmitted by way of at least one pressure pin to a pressure transmission element, which is in operational-contact with the brake-disk packet. The pressure pin and the parking brake piston can be separated from one another, releasing them from their shape-fit union. In this embodiment, the assembly is to comprise in the given succession: an axially acting brake-disk packet, a pressure transmission element, a pressure pin, a piston and a spring. The piston of the service brake serves as an excellent pressure transmission element.

By way of the invented concept, the tolerance problem between the piston and the pressure pin is no longer of concern. In an advantageous manner, the necessary forces called for by a shape-fit connection between the pressure pin and the piston, according to the state of the technology, has been inventively eliminated so that the operational reliability and the functional life of both are increased.

Because of the shape-fit decoupling between the piston and the pressure pin, the rotational movements of the disk packets, which forces are transferred by the pressure transmission element, i.e., by the piston of the service brakes onto the pressure pin, are no longer carried by the parking brake piston.

### BRIEF DESCRIPTION OF THE DRAWING

The invention will now be described, by way of example, with reference to the accompanying drawing. Accordingly, disk packet for the service brakes in common with that of the parking brake is necessary so that the piston of the service brake can serve as pressure transmission unit. There is shown:

FIG. 1 is a schematic sectional view of a parking brake in accord with the state of the technology, and

FIG. 2 is a schematic sectional view of an advantageous embodiment of a parking brake in accord with the present invention.

### DETAILED DESCRIPTION OF THE INVENTION

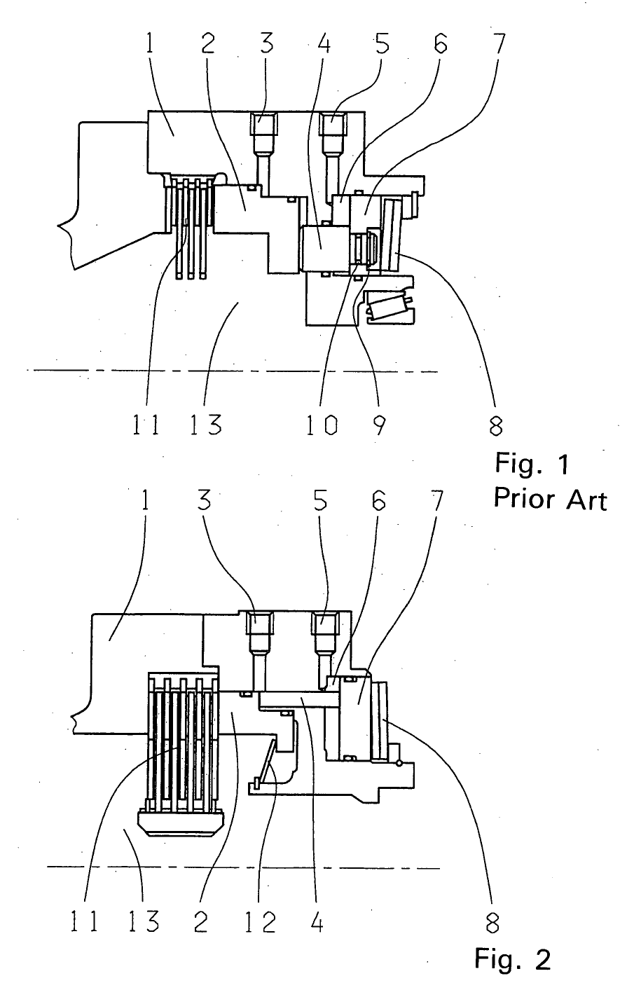

Considering FIG. 1, according to the state of the technology, a parking brake encompasses a brake disk contained in a brake disk packet 11 and enclosed in a brake housing 1 on an axle body. The parking brake also includes at least one pressure pin 4, which is in an operative connection with a piston 2 of the service brake and is also connected with a piston 7, a compression space 6 of which piston can be subjected to pressure for the release of the parking brake by way of the feed line at a connection 5. The reference number 3 designates the line to the connection for filling the piston space, i.e., compression space of the piston 2 of the service brake. For the activation of the parking brake, a plate spring 8 is provided, whereby the spring force is directed in order through the piston 7 of the parking brake, the pressure pin 4 and finally the piston 2 of the service brake, finally reaching the disk packet 11.

For the release of the parking brake, pressure is directed over the line 5 of the piston compression space 6, so that the piston 7 compresses the plate spring 8, thereby freeing the disk packet 11.

The pressure pin 4 is held in a boring 10 of the piston and is shape-fit bound to the piston 7, i.e., by way of a security ring 9, which binding is released and the pin retracted upon a relaxing of the braking activation.

As has already been explained, a rotation, which is effected on the piston 2 by way of the disk packet 11, is transmitted to the pressure pin 4. This action can act in a negative manner on the sealing means and the operational life of the sealing elements of the pressure pin 4.

As may be seen in FIG. 2, according to the invention, a shape-fit decoupling of the piston 2 and the pressure pin 4 is proposed.

As FIG. 2 illustrates, the retraction of the pressure pin 4 occurs upon the release of the parking brake by way of a retraction element 12, which also causes the piston 2 of the service brake to reverse. A second plate spring can well serve as the retraction element and is designated as “retraction element 12”. In this case, the force of the retraction element 12 is greater than the releasing pressure of the parking brake in the piston compression space 6, which generates the force acting upon the end face of the pressure pin 4. With a dependency upon the requirements of design, even a retraction element independent of service braking can be provided.

Within the framework of a particularly advantageous embodiment of the present invention, a proposal is given that the pressure pin 4, within the compression space 6 of the piston 7, is positioned in such a manner that no connection exists between the pressure pin 4 and an axle space, so that a leakage of oil out of the compression space 6 and into the axle space 13 is prevented. According to the invention, between the axle space 13 and the pressure pin 4 in a radial direction, a portion of the piston 2 of the service brake is located.

Again, in accordance with the invention, no sealing means is necessary between the pressure pin 4 and the brake housing 1. In this respect, that between the pressure pin 4 and the brake housing 1, it is provided that a narrow, controlled fissure with a known low leakage can be provided so that a back flow of the leakage oil is enabled through the feed connection 3 into a retrieval tank. This becomes the case when the service brake is not activated and thereby the brake load to the tank is open.

By way of the shape-fit decoupling of pressure pin and parking brake pins, besides the improvement of the operational reliability, there also arises a distinct reduction of the individual construction components and a simplification of the mounting.

Obviously, any advantageous improvement, especially regarding a spatial arrangement of the components of the invented parking brake as to each alone as well as in combination with one another, which improvement is technically an advancement, falls under the protective framework of the present claims without the function of the parking brake as this is presented in the claims. This protection is to be given consideration, even when this improvement is not explicitly presented in the Figures or in the description.

### REFERENCE NUMERALS

1 brake housing
2 piston of the service brake, where service brake=pressure transmission element
3 connection fitting for the filling of the compression space of the piston 2
4 pressure pin
5 connection fitting for the filling of the compression space of the piston 7
6 compression space for the piston 7
7 piston (for the parking brake)
8 plate spring
9 security ring
10 boring
11 disk packet
12 retraction element
13 space for axle

1-6. (canceled)

7. A parking brake for a motor vehicle, the parking brake comprising:
a disk packet on an axle body in a brake housing, and the disk packet having at least one brake disk;
a spring engaging the parking brake via compression of the disk packet;
a piston located adjacent the spring, the piston communicating with a piston compression space which is subjected to a hydraulic pressure for disengaging the parking brake by countering a parking brake engaging force of the spring; and
the disk packet being in operative communication with a pressure transmission element (2), and the piston, via pressurization of the piston compression space, relieving a pressure pin (4) from a brake engaging force of the spring;
wherein the piston (7) is a separate component from the pressure pin (4).

8. The parking brake for a motor vehicle according to claim 7, wherein a retraction element (12) biases the pressure transmission element which biases the pressure pin (4) upon release of the parking brake, and a retraction force of the retraction element (12) is greater than a pressure force acting upon an end face of the pressure pin (4) in the piston compression space (6) when the parking brake is released.

9. The parking brake for a motor vehicle according to 8, wherein the pressure pin (4) is accommodated by the pressure transmission element (2) such that the pressure pin (4) does not communicate with an axle space (13) so as to prevent leakage of hydraulic fluid out of the pressure transmission element (2) into the axle space (13).

10. The parking brake for a motor vehicle according to claim 9, wherein at least a portion of the pressure transmission element (2) is located radially between the axle space (13) and the pressure pin (4).

11. The parking brake for a motor vehicle according to claim 7, wherein the pressure transmission element (2) is a piston of a service brake.

12. The parking brake for a motor vehicle according to claim 11, wherein the retraction element (12) is the piston of the service brake.

13. A parking brake for a motor vehicle, the parking brake comprising:
a spring (8) engaging a first face of a piston (7);
a piston compression space (6) being at least partially defined by a second face of the piston (7), a force of the spring (8) biasing the piston (7) in a first direction for engaging the parking brake, and an increase in hydraulic pressure in the piston compression space (6) biasing the piston (7) in a second direction for disengaging the parking brake;
a first end of a pressure pin (4) abutting with the second face of the piston (7) and a second end of the pressure pin (4) communicating with a pressure transmission element (2), the pressure pin (4) being movable relative to the piston (7);
a parking brake disc packet (11) and a retraction element (12) each communicating with the pressure transmission element (2), the retraction element (2) normally biasing the pressure transmission element (2) and the pressure pin (4) in the second direction;
the force of the spring (8) in the first direction being greater than a force of the retraction element (12) in the second direction when the hydraulic pressure in the piston pressure space (6) decreases, thus enabling biasing of the piston (7), the pressure pin (4) and the pressure transmission element (2) to be biased by the spring (8) in the second direction for engaging the parking brake, and
when hydraulic pressure in the piston compression space (6) increases, the piston (7) being biased in the second direction, against the force of the spring (8), thereby permitting the retraction element (12) to bias the pressure transmission element (2) and the pressure pin (4) in the second direction toward the piston (7) to and disengage the parking brake.

14. The parking brake for a motor vehicle according to 13, wherein the pressure pin (4) is located radially within at least a portion of the pressure transmission element (2) such that the pressure pin (4) is spaced an axle space (13) thereby preventing leakage of hydraulic fluid out of the piston compression space (6) into the axle space (13).

15. The parking brake for a motor vehicle according to claim 13, wherein at least a portion of the pressure transmission element (2) is located radially between the axle space (13) and the pressure pin (4).

16. The parking brake for a motor vehicle according to claim 13, wherein the pressure transmission element (2) is a piston of a service brake.

17. The parking brake for a motor vehicle according to claim 13, wherein the retraction element (12) is the piston of the service brake
